(19) United States
(12) Patent Application Publication
(10) Pub. No.: US 2026/0179126 A1
(43) Pub. Date: Jun. 25, 2026

(54) METHOD AND SYSTEM FOR USING A VIDEO PRESENTATION INTERFACE FOR CREDIT ALLOCATION

(71) Applicant: Muhammad Elhamshari, Middleburg Heights, OH (US)

(72) Inventor: Muhammad Elhamshari, Middleburg Heights, OH (US)

(21) Appl. No.: 18/988,303

(22) Filed: Dec. 19, 2024

(51) Int. Cl. G06Q 30/0279; G06F 3/0482; G06F 3/0484

(52) U.S. Cl. CPC G06Q 30/0279; G06F 3/0482; G06F 3/0484

(57) ABSTRACT

A method for facilitating the allocation of credit to one or more organizations via a video presentation interface is provided. The method includes displaying, in a video presentation interface of a first user, a video, displaying, in the video presentation interface of the first user, a selectable input associated with identifying an organization, receiving an interaction with the selectable input, identifying a first organization, from among a plurality of organizations, based upon the interaction, modifying one or more settings associated with the first user to identify the first organization as being a beneficiary of views of the first user, and responsive to detecting one or more views of one or more videos by the first user after modification of the one or more settings, providing credit associated with the one or more views to a first account of the first organization.

### SUMMARY

This summary is intended to provide an overview of the subject matter of the present disclosure, and is not intended to identify essential elements or key elements of the subject matter, nor is it intended to be used to determine the scope of the claimed implementations. The proper scope of the present disclosure may be ascertained from the claims set forth below in view of the detailed description below and the drawings.

According to one or more exemplary embodiments, the present disclosure is directed to a method for facilitating the allocation of credit to one or more organizations via a video presentation interface is provided. The method includes displaying, in a video presentation interface of a first user, a video, displaying, in the video presentation interface of the first user, a selectable input associated with identifying an organization, receiving an interaction with the selectable input, identifying a first organization, from among a plurality of organizations, based upon the interaction, modifying one or more settings associated with the first user to identify the first organization as being a beneficiary of views of the first user, and responsive to detecting one or more views of one or more videos by the first user after modification of the one or more settings, providing credit associated with the one or more views to a first account of the first organization.

### DESCRIPTION OF THE DRAWINGS

FIG. 1 is an illustration of an exemplary method for facilitating the allocation of credit to one or more organizations via a video presentation interface.

FIG. 2A is an illustration of a video presentation interface being displayed via the first client device.

FIG. 2B is an illustration of the video presentation interface displaying an interface associated with one or more organizations.

FIG. 2C is an illustration of the video presentation interface displaying a profile generation interface.

FIG. 2D is an illustration of a first client device transmitting one or more information associated with the first user to an AI-based recommendation model.

FIG. 2E is an illustration of the video presentation interface displaying an interface associated with identifying the one or more organizations.

FIG. 2F is an illustration of the video presentation interface displaying a video interface.

FIG. 2G is an illustration of video interface displaying a first video.

FIG. 2H is an illustration of video interface.

FIG. 2I is an illustration of using an analytics feature to access analytics information associated with one or more currently selected target organizations.

FIG. 2J is an illustration of using the analytics feature to access analytics information associated with one or more historical selected target organizations.

FIG. 2K-2L is an illustration of using a feature to access one or more videos associated with the first organization.

FIG. 2M-2N is an illustration of using a recommendation feature to access one or more other users recommend within the video interface.

FIG. 2O is an illustration of the video interface comprising a ranking feature.

FIG. 2P is an illustration of the video interface comprising a collaboration feature and/or an export feature.

FIG. 3A-3B is an illustration an interface associated with the first organization.

FIG. 4 is an illustration of an exemplary computer-readable medium comprising processor-executable instructions, wherein the processor executable instructions may be configured to embody one or more of the provisions set forth herein.

FIG. 5 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

In accordance with the present disclosure, one or more computing devices and/or techniques for facilitating the allocation of credit (e.g., donation) to one or more organizations via a video presentation interface are provided. In some examples, the video presentation interface may provide a mechanism to allow a user to select one or more target organizations to receive credit in compensation for content views (e.g., views of videos such as informational videos, entertainment videos, advertisements, etc. and/or other types of content, such as images, augmented reality (AR) content, a blog post, etc.). Alternatively and/or additionally, one or more target organizations may be automatically selected for and/or recommended to the user. Responsive to detecting one or more views of one or more videos by the user, credit associated with the one or more views may be provided to one or more accounts of one or more target organizations associated with the user.

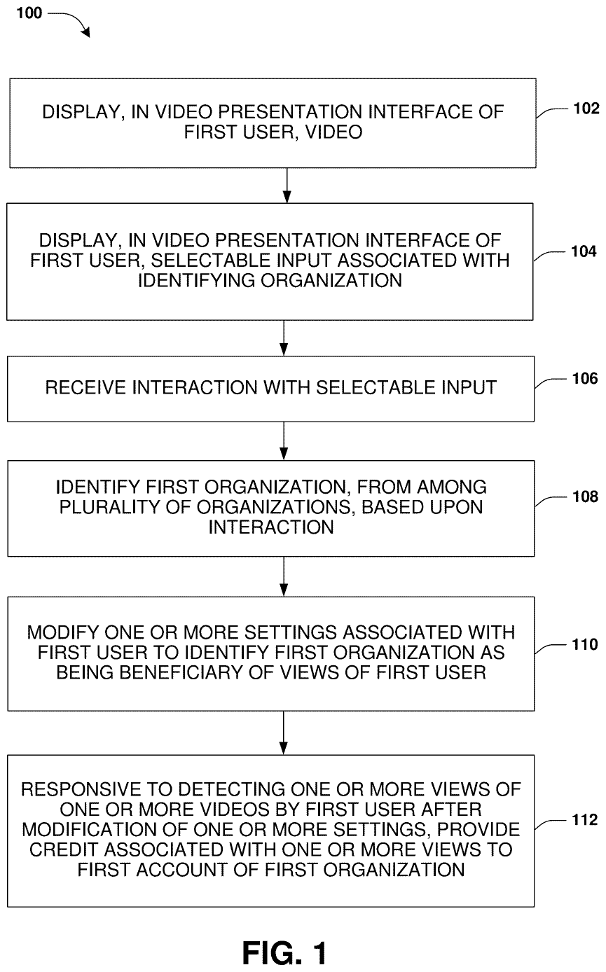

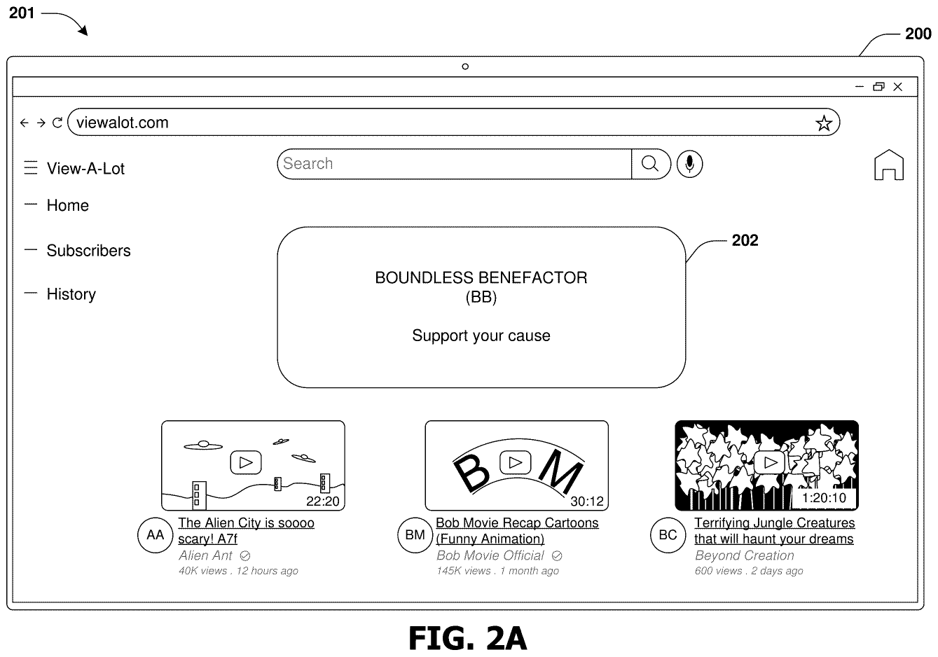

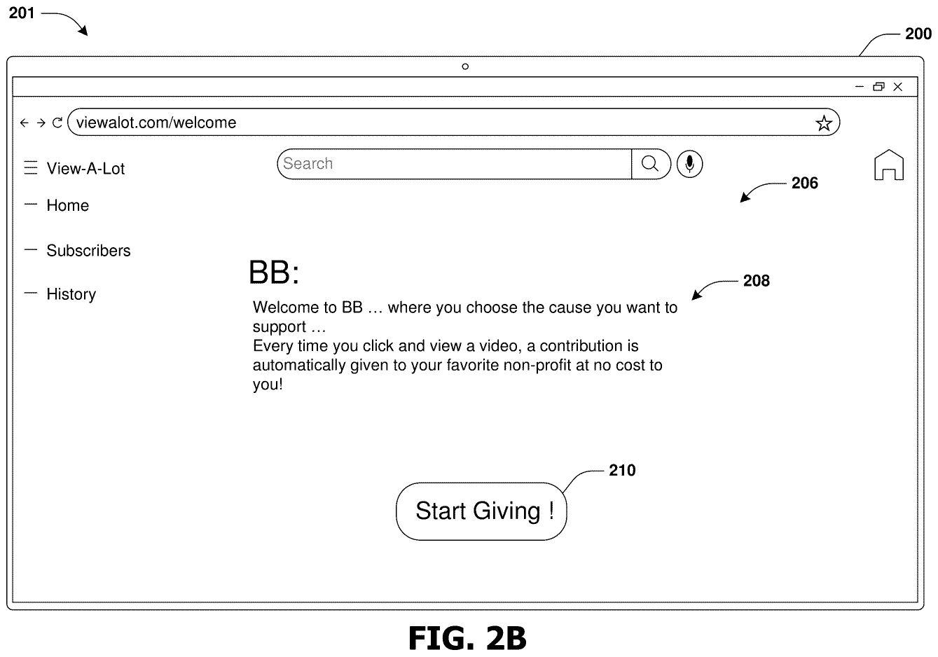

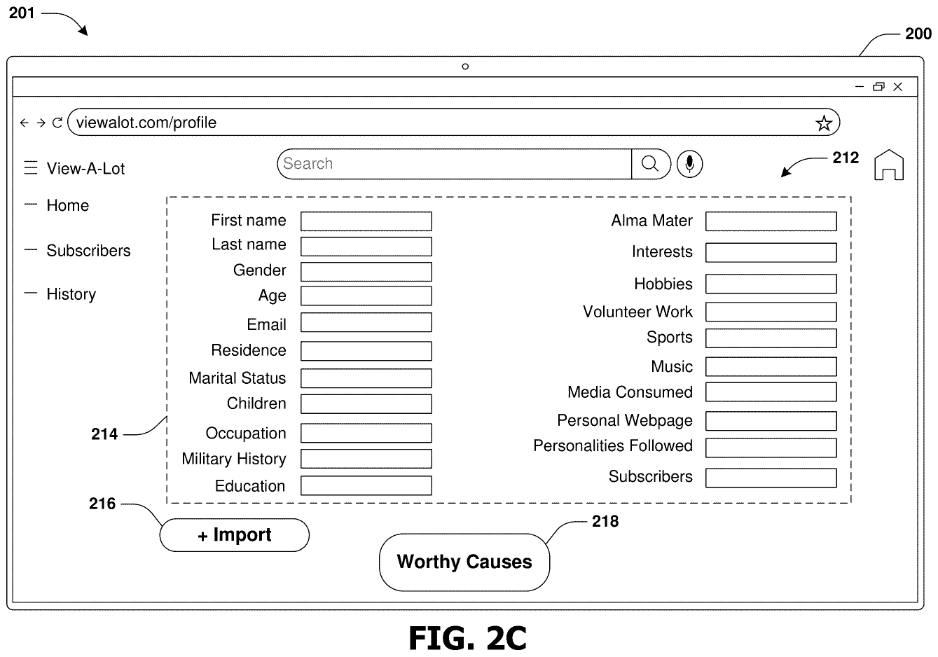

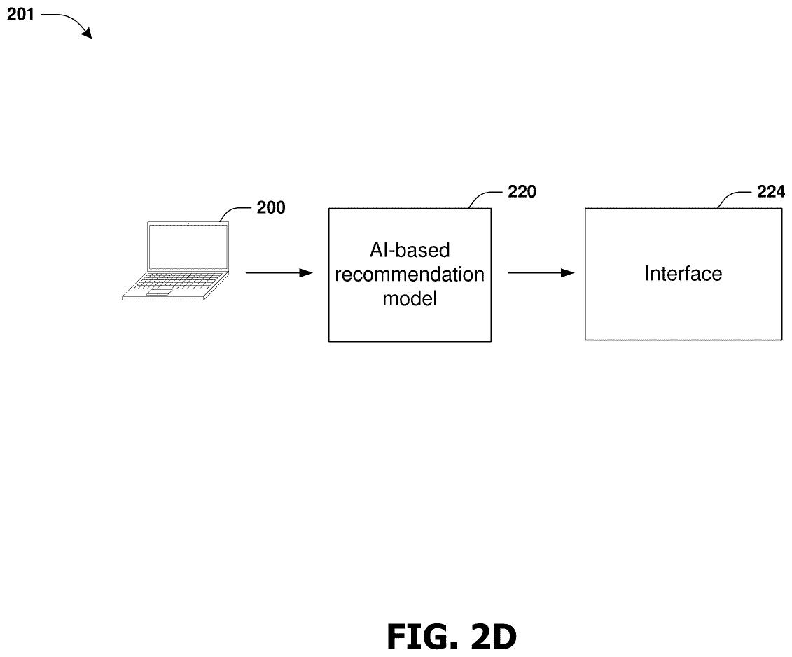

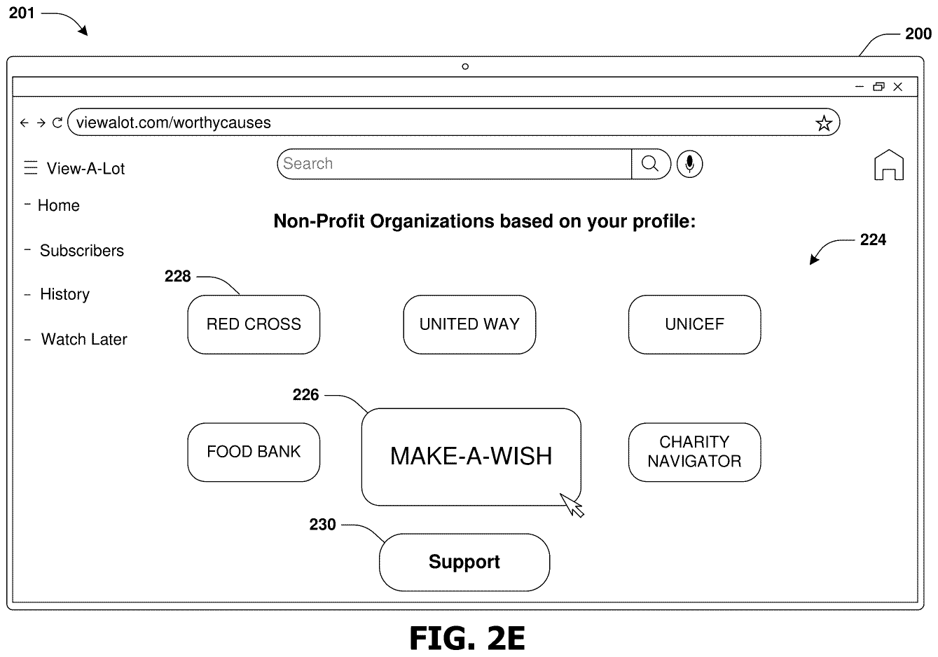

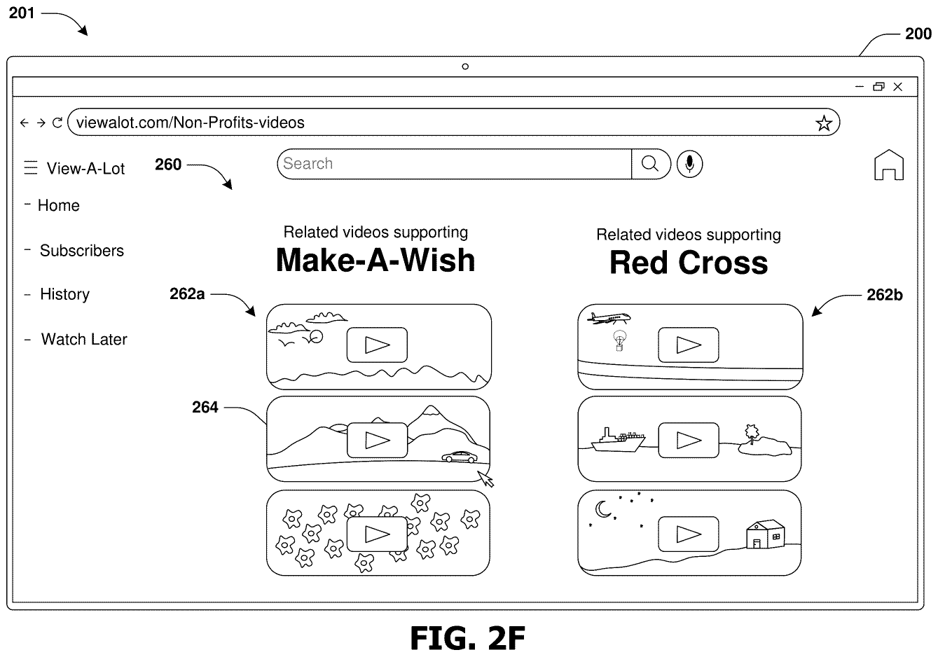

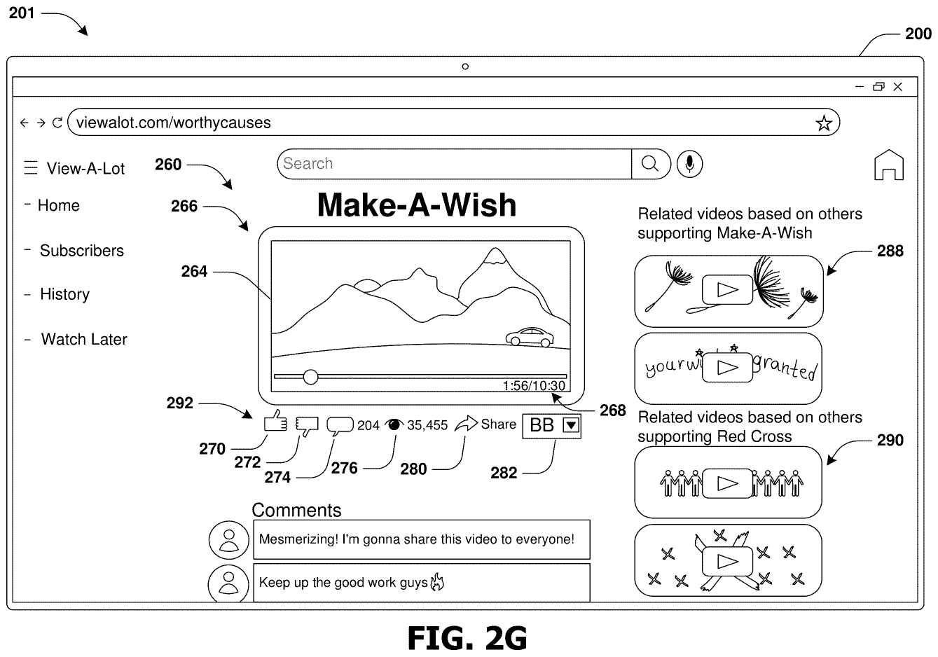

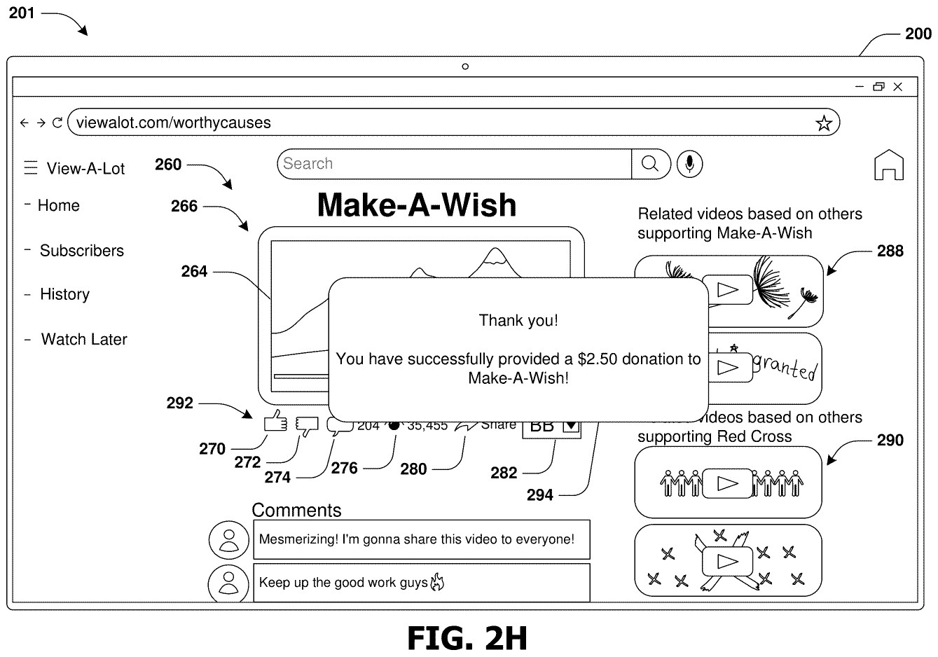

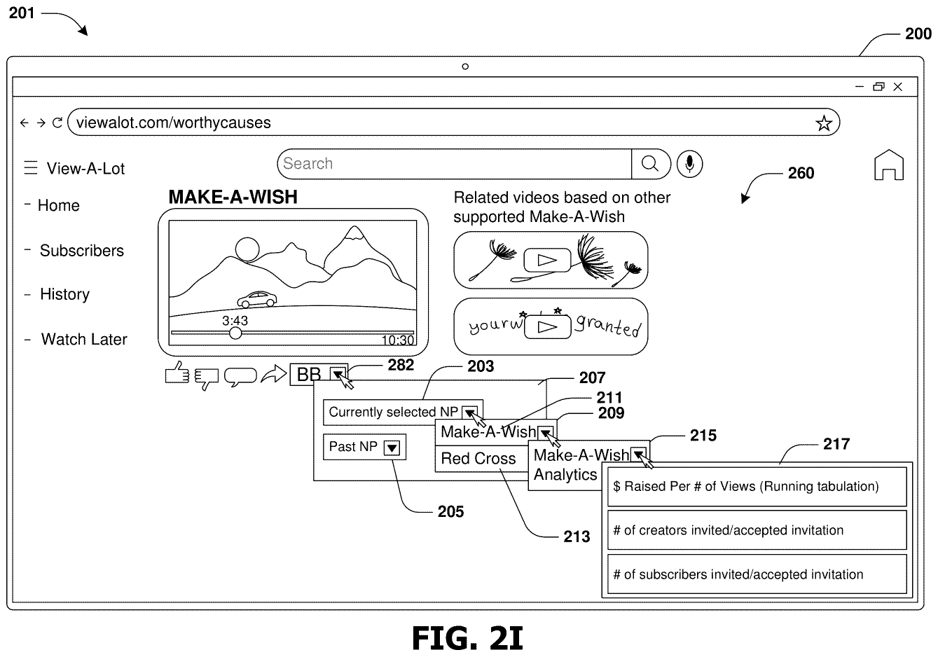

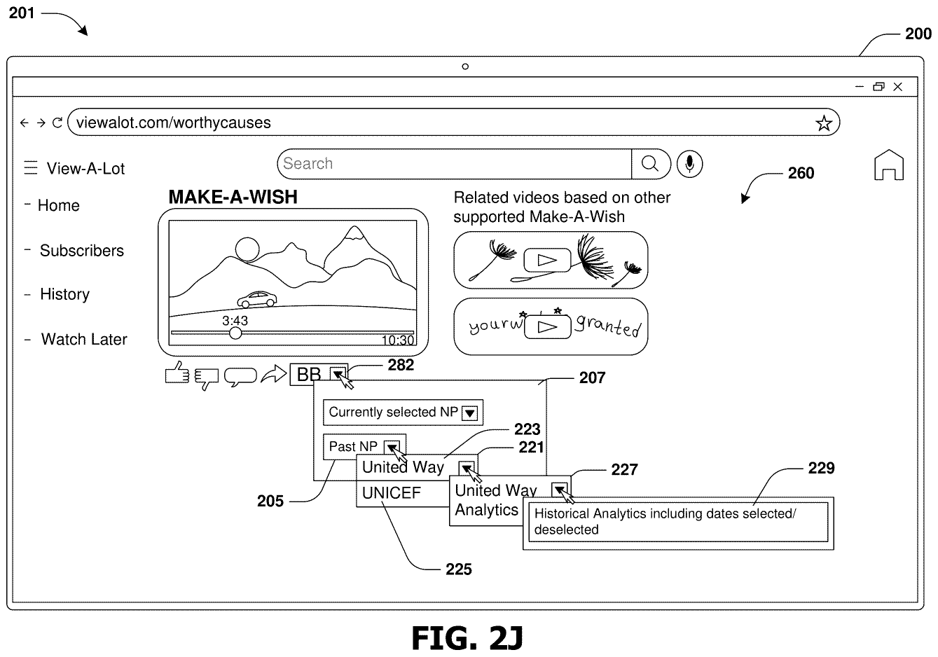

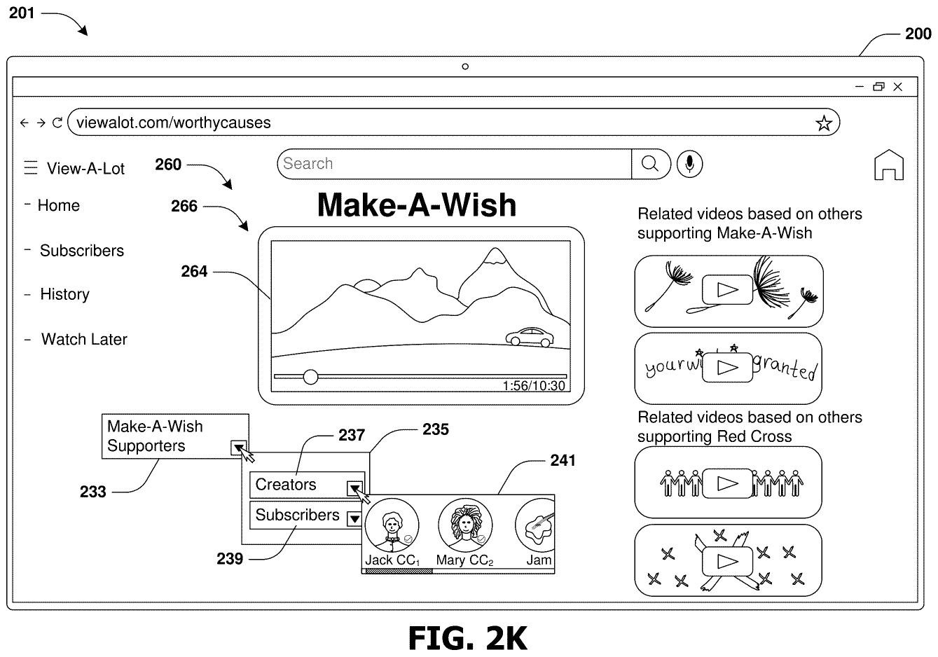

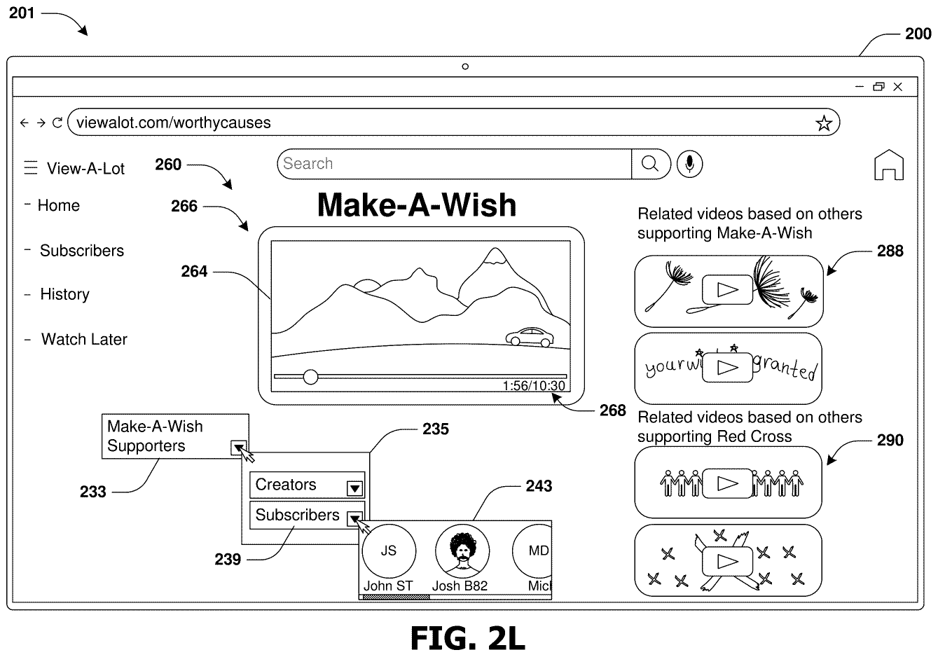

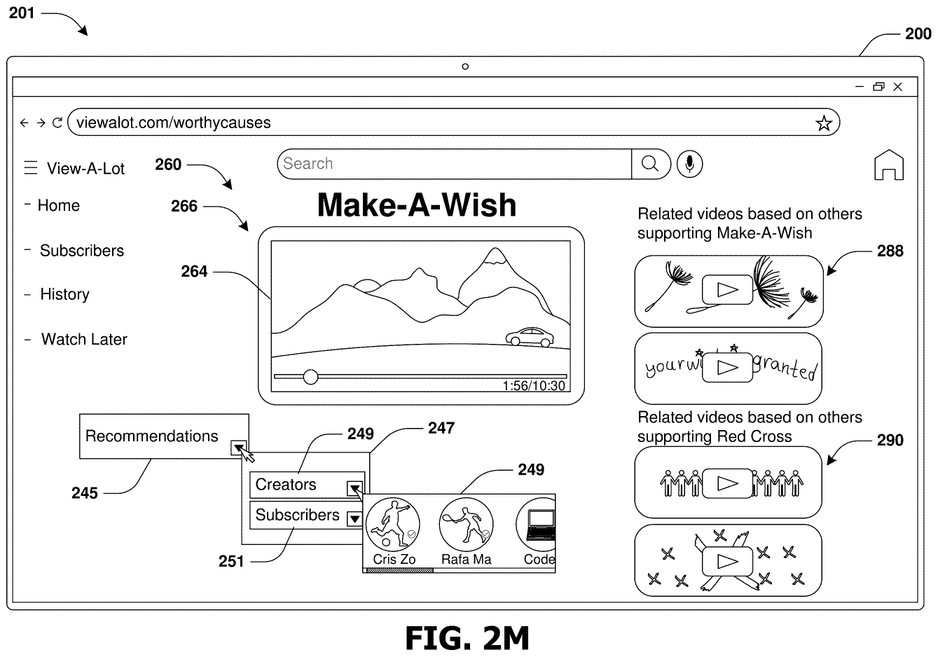

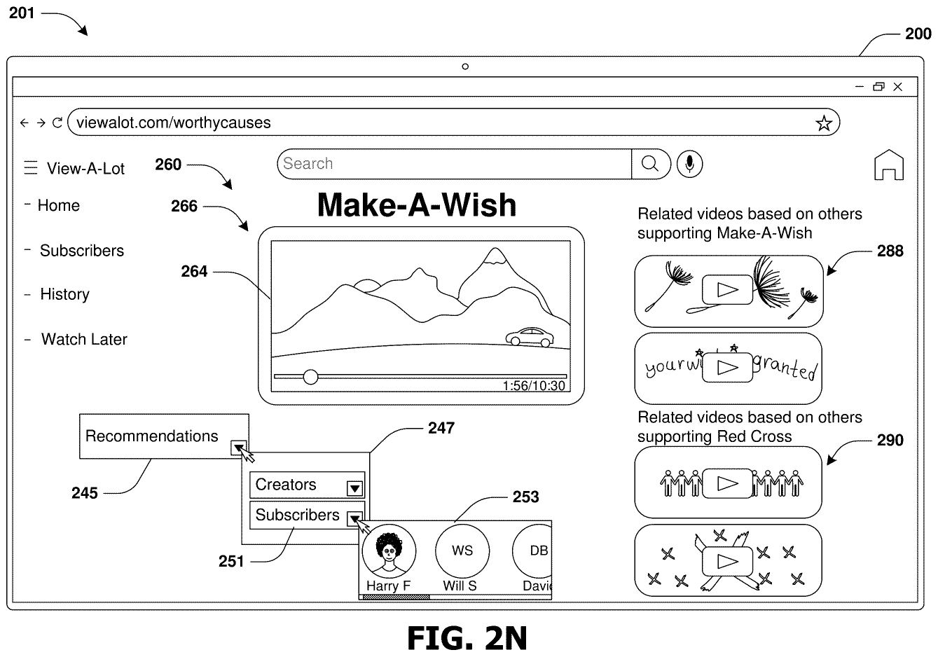

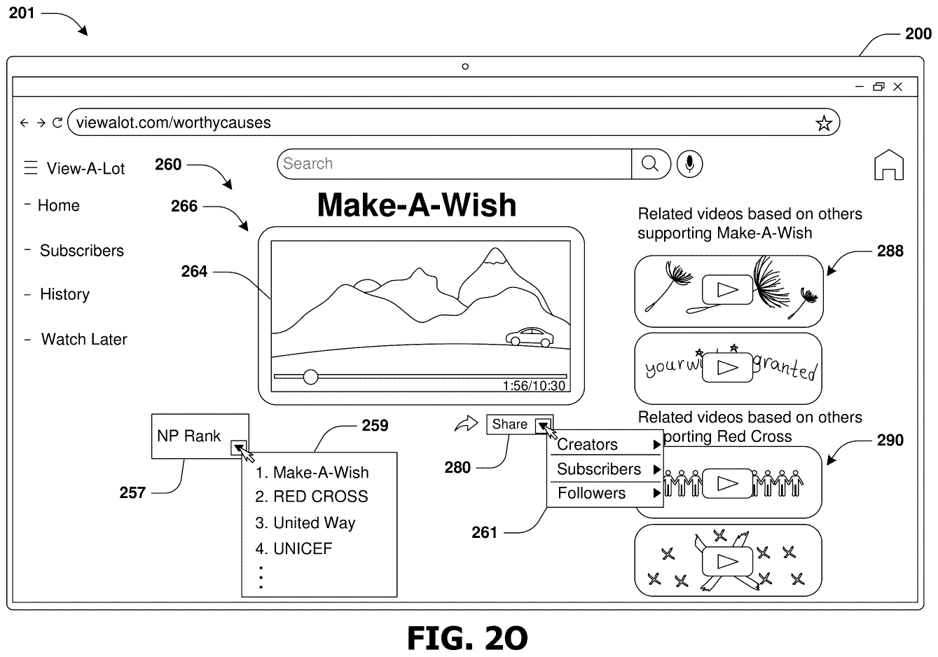

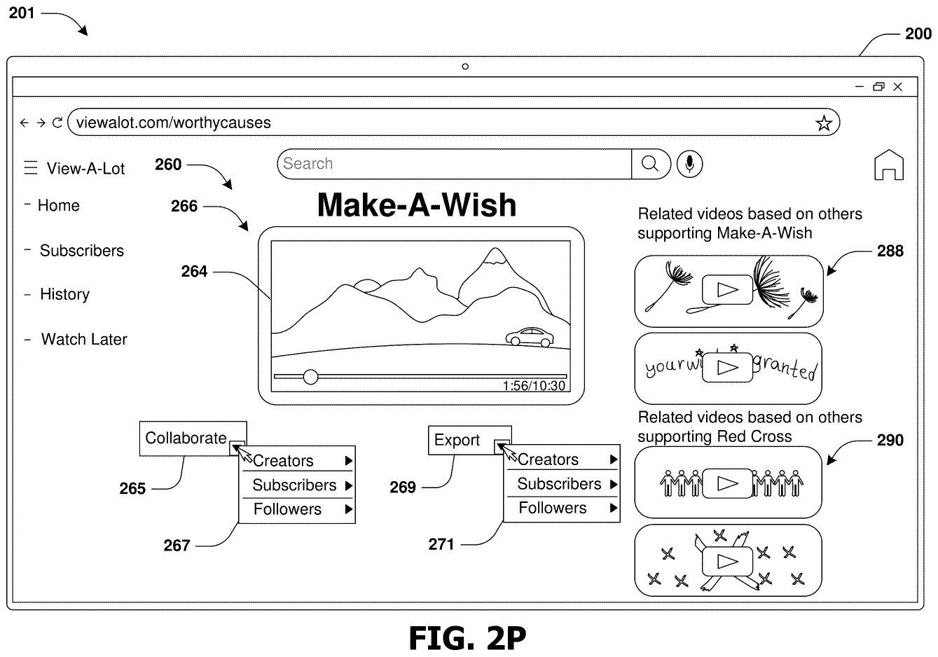

An embodiment of facilitating the allocation of credit to one or more organizations via a video presentation interface is illustrated by an example method 100 of FIG. 1, and is further described in conjunction with system 201 of FIGS. 2A-2O. In some examples, a credit allocation system is provided. The credit allocation system may use a video presentation interface to present videos to users, and/or may facilitate credit to one or more target organizations based upon the views of the videos.

Accordingly, at 102, a video presentation interface of a first user displays a video.

At 104, the video presentation interface may display a selectable input associated with identifying an organization. In some examples, the selectable input may comprise buttons, checkboxes, radio buttons, dropdown menus, sliders, and/or other selectable inputs.

At 106, an interaction with the selectable input may be received. In some examples, the interaction may be indicative of the first user selecting the selectable input via an input device.

At 108, a first organization from one or more organizations may be identified based upon the interaction.

At 110, one or more settings associated with the first user may be modified to identify the first organization being a beneficiary of views of the first user.

At 112, in response to detecting one or more views of one or more videos by the first user after modification of the one or more setting, provide credit associated with the one or more views to a first organization.

In some examples, the one or more settings are stored in a first memory of the credit allocation system. In some examples, in response to identifying the first organization, the credit allocation system clears the first memory, and after clearing the first memory, the credit allocation system stores an indication of the first organization in the first memory.

FIG. 2A illustrates the video presentation interface being displayed via the first client device (shown with reference 200). In an example, the video presentation interface may comprise a selectable input 202 (e.g., a button) associated with one or more organizations.

FIG. 2B illustrates the video presentation interface displaying an interface 206 (e.g., user interface, etc.) associated with one or more organizations. In some examples, the homepage 206 may comprise a text (e.g., text area) 208 to encourage one or more users (e.g., a first user) to join the system 201. In some examples, the webpage may comprise a selectable input 210 associated with receiving one or more information.

FIG. 2C illustrates the video presentation interface displaying a profile generation interface (shown with reference 212). The profile generation interface 212 may comprise an actionable form 214 (e.g., an interactive form comprising selectable inputs and/or text fields) for submitting one or more information associated with the first user. In some examples, the profile generation 212 may comprise a first selectable input 216 for extracting one or more information associated with the first user across social media platforms. In an example the first selectable input 216 may perform one or more email mining technique to extract one or more information associated with the first user.

In some examples, the profile generation interface 212 may comprise a second selectable input associated with identifying one or more organizations. In some examples, identifying the one or more organizations may be based upon the user filling up the actionable form 214 and/or one or more information extraction by via the first selectable input. FIG. 2D illustrates the first client device 200 transmitting one or more information associated with the first user to an AI-based recommendation model (shown with reference number 220). The AI-based recommendation model 220 may analyze the one or more information to identify the one or more organizations for the first user. In some examples, the one or more information may comprise demographic information of the first user, email addresses of the first user, and/or other related information which helps the AI-based recommendation model 220 to identify the one or more organizations. In some examples, the one or more organizations may be identified using a machine learning model. The machine learning model may, for example, comprise at least one of a neural network, a tree-based model, a machine learning model used to perform linear regression, a machine learning model used to perform logistic regression, a decision tree model, a support vector machine (SVM), a Bayesian network model, a k-Nearest Neighbors (k-NN) model, a K-Means model, a random forest model, a machine learning model used to perform dimensional reduction, a machine learning model used to perform gradient boosting, etc. In some examples, the one or more organizations may be presented to the first user via an interface 224 (e.g., graphical user interface)

FIG. 2E illustrates the video presentation interface displaying an interface 224 associated with identifying the one or more organizations. In some examples, the user may select a first organization from the one or more organizations provided via the AI-based recommendation model 220. In an example, the user may select a first selectable input 226 associated with a first organization. In an example, the first user may select a second selectable input 228 associated with a second organization. Furthermore, the user may select a third selectable input 230 to confirm the selection of the first organization and/or the second organization.

FIG. 2F illustrates the video presentation interface displaying a video interface 260. In some examples, the video interface 260 may display a first set of one or more videos 262a (e.g., a set of one or more videos) associated with the first organization and/or a second set of one or more videos 262b (e.g., a set of one or more videos) associated with the second organization to the first user. In some examples, based upon the first user selecting a first video 264 of the first set of one or more videos 262a, the video interface 260 may display the first video 264 to the first user. In some examples, in response to the selection of the first video 264, the first client device 200 may transmit a first request to be provided with the first video 264 for presentation on the first client device 200.

FIG. 2G illustrates video interface 260 displaying the first video 264. For example, the video interface 260 may comprise a display area 266 in which the first video 264 is displayed. In some examples, the video interface 260 may provide one or more social media features 292 comprising (i) a positive reaction button 270 (e.g., a like button), (ii) a negative reaction button 272 (e.g., a dislike button), (iii) a comment button 274 (e.g., to post and/or view comments about the first video 264), (iv) a view count 276 (e.g., a quantity of times that the first video was viewed), (v) a share button 280 (e.g., to share the first video 264 and/or a link to the first video 264 with one or more other users) and/or (vi) one or more other features. In some examples, the video interface 260 may comprise an analytics feature 282 (e.g., a drop-down menu, a button and/or other types of interface feature).

In some examples, the display area 266 (and/or a display size with which the one or more videos are displayed) may be sized depending on at least one of a size of a display of the first client device 200, a display mode of the video interface 260 (e.g., at least one of full-screen mode, half-window mode, etc.), an aspect ratio of the one or more videos, etc. In some examples, the video interface 260 may display a time indication 268 at least one of adjacent to, overlaying, below, etc. the display area 266 of the video interface 260. The time indication 268 may indicate a time of a video that is being presented with respect to a total duration of time. For example, the time indication 268 may indicate the total duration of time and/or a playback position (e.g., a current time) with respect to the total duration of time.

In some examples, based upon the first user viewing the first video 264, the system 201 may determine a first credit (e.g., an amount of credit) to provide to the first organization. In some examples, the first credit may be determined based upon an amount, of the first video 264, viewed by the first user. For example, if the first user views merely a first portion of the first video 264 (e.g., the first does not watch an entirety of the first video 264), the first credit may be determined based upon the first portion. In an example, when the first portion is 30% of the first video 264, the first credit may be about 0.3×C, and/or when the first portion is 40% of the first video 264, the first credit may be about 0.4×C. In some examples, C is a predefined value associated with the first video 264 and/or the first organization. In some examples, the first credit may be determined based upon whether the first video 264 was viewed (by the first user, for example) in its entirety. For example, the first credit may be a greater value in a scenario in which the first video 264 was viewed (by the first user, for example) in its entirety than in a scenario in which merely a portion of the first video 264 was viewed (e.g., the first user did not watch an entirety of the first video 264).

In some examples, responsive to the first user viewing the first video 264 and/or determining the first credit, the credit allocation system may provide the first credit to a first account (e.g., a bank account, etc.) associated with the first organization. For example, the credit allocation system may generate transaction instructions based upon the first credit and/or transmit the transaction instructions to a transaction system. The transaction instructions may be indicative of (i) the first credit (e.g., a monetary amount), (ii) one or more characteristics of the first credit (e.g., an indication of the first video 264), (iii) a recipient account of the first credit (e.g., the first account associated with the first organization) and/or (iv) other information. In some examples, in response to receiving the transaction instructions, the transaction system may perform a transaction according to the transaction instructions to transfer the first credit to the first account.

In some examples, in response to providing the transaction instructions to the transaction system and/or performing the transaction (and/or in response to determining the first credit), the video interface 260 may display an indication of the first credit. FIG. 2H illustrates the video interface 260 displaying an alert 294 (e.g., prompt, message) indicative of the first credit.

In some examples, the video interface 260 may comprise a first set of related videos 288 to the first organization. In an example, the first user may select a second video of a first set of related videos 288 associated with the first organization and view the video to provide credit to the first organization. In some examples, the video interface 260 may comprise a second set of related videos 290 to the second organization. In an example, the first user may select a third video of a second set of related videos 290 associated with the second organization and view the video to provide credit to the second organization. In some examples, the first organization may receive views from the first user during a first defined time period (e.g., weekends, special seasons, special holidays) and/or first defined circumstances (e.g., the first user is ill, depressed, etc.). In some examples, the second organization may receive views from the first user during a second defined time period (e.g., weekdays, special seasons, special holidays for example Memorial Day) and/or second defined circumstances (e.g., the first user suffering a bereavement, etc.).

FIG. 2I illustrates use of an analytics feature 282 to access analytics information associated with one or more currently selected target organizations. In some examples, the one or more currently selected target organizations comprise target organizations that are currently active and/or enabled for the first user. In some examples, in response to a selection of the analytics feature 282, an interface 207 (e.g., a menu of items) comprising a current target feature 203 (e.g., a drop-down menu) and/or a past target feature 205 (e.g., a drop-down menu) may be displayed. In some examples, in response to a selection of the current target feature 203, an interface 209 (e.g., a menu of items) comprising items associated with the one or more currently selected target organizations may be displayed. The interface 209 may comprise an item 211 associated with the first organization (e.g., Make-A-Wish) and/or an item 213 associated with the second organization (e.g., Red Cross). In some examples in response to a selection of the item 211, an item 215 associated with accessing analytics information associated with the first organization may be displayed. In some examples in response to a selection of the item 215, an interface 217 indicative of a set of analytics information associated with the first organization may be displayed. The interface 217 may comprise a first analytical information which indicates (e.g., displays in real-time) an amount of money raised by the first user via viewing one or more videos associated with the first organization. FIG. 2J illustrates use of the analytics feature 282 to access analytics information associated with one or more historical selected target organizations. In some examples, the one or more historical selected target organizations comprise target organizations that were previously active and/or enabled for the first user, but not currently active and/or enabled for the first user. In some examples, in response to a selection of the past target feature 205, an interface 221 (e.g., a menu of items) comprising items associated with the one or more historical target organizations may be displayed. The interface 221 may comprise an item 223 associated with the third organization (e.g., United Way) and/or an item 225 associated with the fourth organization (e.g., UNICEF). In some examples in response to a selection of the item 223, an item 227 associated with accessing analytics information associated with the third organization may be displayed. In some examples in response to a selection of the item 227, an interface 229 indicative of a set of historical analytics information associated with the third organization may be displayed. The interface 229 may comprise a first historical analytical information which indicates (e.g., displays) an amount of money by the first user via viewing one or more videos associated with the third organization.

FIG. 2K-2L illustrate use of a feature 233 (e.g., support feature) to access one or more videos (e.g., informational videos, promotional videos, etc. and/or other types of videos) associated with the first organization. In some examples, the one or more videos may be recommended based upon one or more other users viewing (e.g., supporting, raising money due to video watching, etc.) the one or more videos associated with the first organization. In some examples, the one or more other users may comprise one or more creators (e.g., content creators) and/or one or more subscribers which are active (e.g., logged in) within the system. In an example, the one or more creators may be indicative of users having more than a threshold amount (e.g., more than about 100000) of subscribers and/or created videos to raise money for the first organization. In some examples, in response to a selection of recommendation feature 233, an interface 235 (e.g., a menu of items) comprising items associated with the one or more other users may be displayed. The interface 235 may comprise an item 237 associated with one or more creators and/or an item 239 associated with the one or more subscribers. In some examples in response to a selection of the item 237, an interface 241 indicative of a set of creators associated with the one or more creators may be displayed. In some examples, the first user may interact with the interface 241 to view one or more videos associated with the first organization which may be viewed by one or more creators. In some examples in response to a selection of the item 239, an interface 243 (shown in FIG. 2L) indicative of a set of creators associated with the one or more subscribers may be displayed. In some examples, the first user may interact with the interface 243 to view one or more videos associated with the first organization which may be viewed by one or more subscribers.

FIG. 2M-2N illustrate use of a recommendation feature 233 to access one or more other users recommend within the video interface 260. In some examples, based upon a first user submitting one or more information to the actionable form 214 one or more other users may be displayed to the first user. In some examples, in response to a selection of recommendation feature 245, an interface 247 (e.g., a menu of items) comprising items associated with the one or more other users may be displayed. The interface 247 may comprise an item 249 associated with one or more creators and/or an item 251 associated with the one or more subscribers. In some examples in response to a selection of the item 249, an interface 249 indicative of a set of creators associated with the one or more creators may be displayed. In some examples, the first user may interact with the interface 249 to view one or more creators associated with the first organization which are having similar interests. In some examples in response to a selection of the item 251, an interface 253 (shown in FIG. 2L) indicative of a set of creators associated with the one or more subscribers may be displayed. In some examples, the first user may interact with the interface 253 to view one or more creators associated with the first organization which are having similar interests.

FIG. 2O illustrates the video interface 260 comprising a ranking feature 257. In some examples, in response to a selection of the ranking feature 257, an interface 259 indicative of one or more organizations may be displayed. In some examples, one or more organizations may be ranked based upon the first user interaction (e.g., viewing videos, sharing, etc.) with one or more organizations (e.g., included one or more target organizations) and/or analyzing a first user profile. In some examples, the video interface 260 may comprise a share button 280 to share the first video 264 and/or a link to the first video 264 with one or more other users. In some examples, in response to selection of the share button 280, an interface 261 comprising one or more other users may be displayed. In some examples, the one or more other users, may comprise one or more creators (e.g., content creators), one or more subscribers, and/or one or more followers (e.g., user which follow the first user).

FIG. 2P illustrates the video interface 260 comprising a collaboration feature 265 and/or an export feature 269. In some examples, the first user may collaborate with one or more other users based upon the message (e.g., content) of the first video 264. In some examples, in response to selection of the collaboration feature 265, an interface 267 may be displayed. The interface 267 may allow sending of a collaboration link (e.g., collaboration message) to the one or more other users. In some examples, in response to a selection of the export feature 269, an interface 271 may be displayed. The interface 271 may allow sending of one or more first user analytics (shown in FIG. 6B) to the one or more other users.

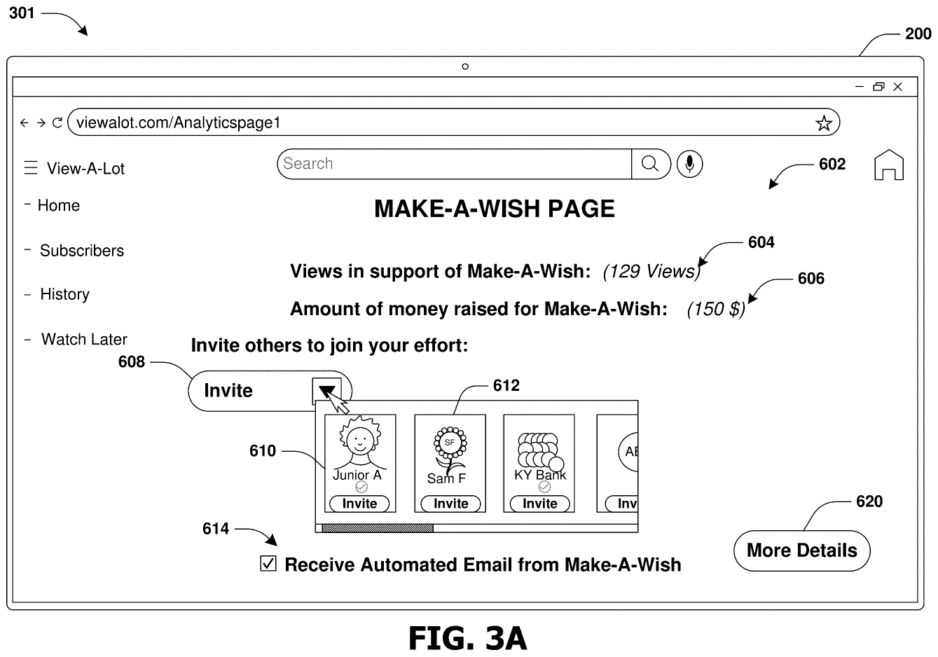

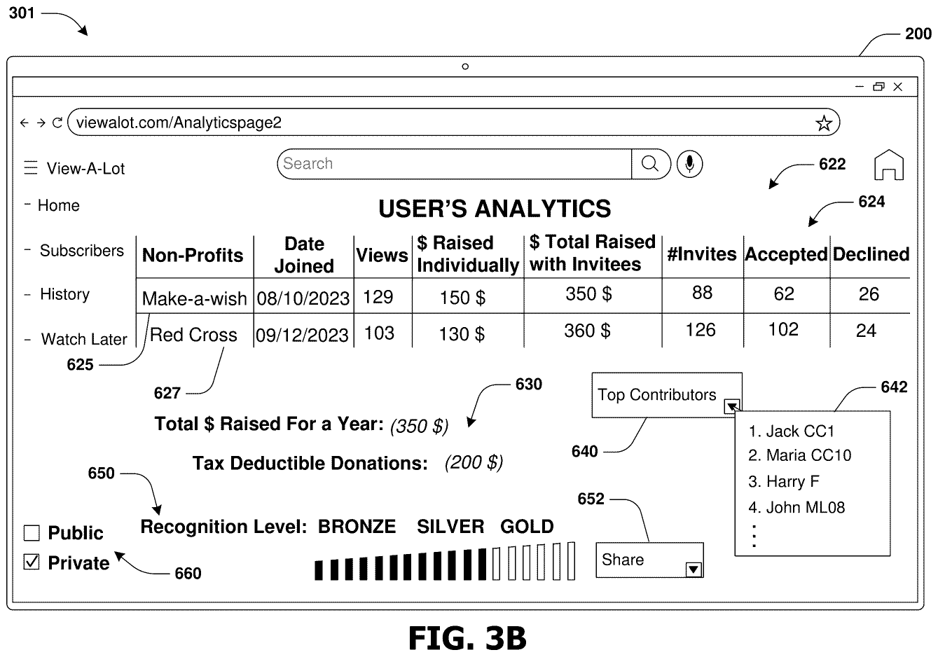

FIG. 3A-3B illustrates an interface 302 (e.g., a webpage) associated with the first organization. In some examples, the interface 302 may comprise a view count indicator 304 and/or a credit (e.g., donation) indicator 306 associated with the first organization. In some examples, based upon the first user viewing the one or more videos associated with the first organization, the value (e.g., numerical value) of the view count indicator 304 and the value of the credit indicator 306 may increase. The interface 302 may comprise a selectable input 308 (e.g., a drop-down menu) to display one or more other users to the first user. In an example, the first user may send an invitation (e.g., an invitation link) to the one or more other users (e.g., for example to a first creator 310 and/or the first subscriber 312) to invite the one or more other users to support the first organization. In some examples, the interface 302 may comprise a selectable input 314 (e.g., a checkbox). The selectable input 314 may allow the user to confirm receiving one or more emails from the first organization. The one or more emails may comprise emails (e.g., promotional emails, canceling subscription emails, collaboration emails, etc.). In some examples, the interface 302 may comprise a selectable input 320 to provide one or more first user analytics to the first user.

FIG. 3B illustrates an interface 322 in response to the first user selecting the selectable input 320. In some examples, the interface 322 may comprise a data structure 324. In some examples, the data structure 324 may comprise the one or more first user analytics. The one or more first user analytics may comprise a first item 325 and/or a second item 327. In some examples, the first item 325 may be indicative of the first user selecting a first organization over a first period of time (e.g., about a year). In an example, the first item 325 may be indicative of one or more information associated with the first organization comprising at least one of (i) views of the first user, (ii) a first amount of credit raised by the first user (e.g., raised individually) for the first organization, (iii) a first total amount of credit raised by the first user and invitees associated with the first user (e.g., total raised with invitees), (iv) number of invitation sent via the first user (e.g., to support the first organization), (v) number of invitation accepted and/or declined and/or (vi) other information. In some examples, the second item 327 may be indicative of the first user selecting a second organization over a second period of time (e.g., less than about a year). In an example, the second item 327 may be indicative of one or more information associated with the second organization comprising at least one of (i) views of the first user, (ii) a second amount of credit raised by the first user (e.g., raised individually), (iii) a second total amount of credit raised by the first user and invitees associated with the first user (e.g., total raised with invitees), (iv) number of invitation sent via the first user (e.g., to support the first organization), (v) number of invitation accepted and/or declined and/or (vi) other information. In some examples, the interface 322 may comprise a financial feature 330 associated with one or more organizations. The financial feature 330 may be indicative of the first total amount of credit and/or a tax amount deducted from the first total amount of money. In some examples, the interface 322 may comprise a user ranking feature 340. In some examples, in response to a selection of the user ranking feature 340, an interface 342 indicative of one or more users (e.g., one or more creators, one or more subscribers, etc.) may be displayed. In some examples, one or more users may be ranked based upon user interactions of the one or more users (e.g., viewing videos, creating content, total amount of money raised, etc.) with one or more organizations. In some examples, the interface 322 may comprise a level of support feature 350 associated with the first user. In some examples, the level of support may be determined based upon the number of views associated with the first user and/or total amount of credit the first user raised for one or more organizations. In some examples, the interface 322 may comprise a selectable input 352. In an example, based upon an interaction with the selectable input 352, a first user may export (e.g., send) the one or more first user analytics (e.g., the level of support) to the one or more other users (e.g., a second user) and/or one or more organizations. In some examples, the interface 322 may comprise a selectable input 360 (e.g., a checkbox). The selectable input 360 may allow the user to change the privacy setting of interface 322. In some examples, the user may change the privacy setting to keep the one or more first user analytics private (e.g., via selecting private feature) and/or allow the one or more other users to view the one or more first user analytics (e.g., via selecting public feature).

In some examples, subsequent to using the machine learning model of the AI-based recommendation model 220 to determine the one or more organizations, the machine learning model may be updated to generate an updated version of the machine learning model based upon usage feedback indicative of one or more user interactions with one or more interfaces (e.g., the interface 224 of the video presentation interface). In some examples, the usage feedback is indicative of whether the user selected and/or donated to an organization of the one or more organizations provided using the machine learning model. In some examples, the machine learning model may be updated (e.g., trained) by updating trainable parameters of the machine learning model, using the usage feedback, to generate the updated version of the machine learning model. In some examples, the updated version of the machine learning model may be used to (more accurately, for example) identify organizations to suggest to users. In this way, a closed-loop process is implemented allowing usage of feedback (e.g., the usage feedback) to tailor the machine learning model and/or continuously and/or periodically update the machine learning model used to determine and/or suggest organizations for users, thereby improving (e.g., continuously and/or periodically improving over time) a quality and/or accuracy of organization identification and/or suggestion. Closed-loop control may reduce errors and produce more efficient operation of a computer system which implements the machine learning model. The reduction of errors and/or the efficient operation of the computer system may improve operational stability and/or predictability of operation. Accordingly, using processing circuitry to implement closed-loop control described herein may improve operation of underlying hardware of the computer system.

In some examples, the credit allocation system comprises a data storage and retrieval system for the first memory (e.g., computer memory) of the credit allocation system. The data storage and retrieval system may comprise means for configuring the first memory according to a logical table. The logical table may include a plurality of logical rows, wherein each of the plurality of logical rows includes an object identification number (OID) to identify each of the plurality of logical rows, and/or wherein each of the plurality of logical rows corresponds to a record of information. The logical table may include a plurality of logical columns intersecting the plurality of logical rows to define a plurality of logical cells, each wherein each of the plurality of logical columns include an OID to identify each of the logical columns. The data storage and retrieval system may comprise means for indexing data stored in said table. In some examples, each logical cell of one, some and/or all of the plurality of logical cells stores a current organization being a beneficiary of views of a user. In some examples, in response to determining the first organization being a beneficiary of views of the first user, an indication of the beneficiary of views of the first user may be stored in a first logical cell of the plurality of logical cells. In some examples, in response to determining the second organization being a beneficiary of views of the first user, an indication of the beneficiary of views of the first user may be stored in a second logical cell of the plurality of logical cells.

In some examples, a second memory of the credit allocation system comprises a quarantine sector, a non-quarantine sector and/or a boot sector, wherein the quarantine sector may be isolated from (e.g., physically isolated from) the non-quarantine sector and/or the boot sector. In some examples, code in the quarantine sector may be prevented from performing write actions on other memory sectors, such as the non-quarantine sector and/or the boot sector. In some examples, in response to the credit allocation system receiving an electronic communication, the electronic communication is stored in the quarantine sector of the second memory. In some examples, the electronic communication may comprise a request for content from a client device (e.g., the request for content may comprise the first request to be provided with the first video 264). In some examples, the credit allocation system extracts (via file parsing, for example) a malicious code from the electronic communication to create a sanitized electronic communication. The extraction of the malicious code may comprise (i) scanning the communication for an identified beginning malicious code marker, (ii) flagging each scanned byte between the beginning marker and a successive end malicious code marker, (iii) continuing scanning until no further beginning malicious code marker is found, and/or (iv) creating a new data file by sequentially copying non-flagged data bytes (e.g., all non-flagged data bytes) into a new file that forms a sanitized communication file. In some examples, the credit allocation system transfers the sanitized electronic communication to the non-quarantine sector of the second memory. In some examples, the credit allocation system deletes data remaining in the quarantine sector (e.g., the credit allocation system deletes all data remaining in the quarantine sector).

In some examples, adaptive monitoring of traffic data through a network appliance connected between computing devices (e.g., the computing devices may comprise at least one of (i) a server that hosts the first video 264 and/or is configured to provide the first video 264 for presentation to the first client device 200 and/or other client devices, (ii) the first client device 200 and/or one or more other client devices) is performed. In some examples, the network appliance and/or the credit allocation system collect traffic data relating to the network traffic passing through the network appliance, the traffic data comprising network delay, packet loss, and/or jitter. In some examples, the network appliance and/or the credit allocation system compare at least one of the collected traffic data to a predefined threshold. In some examples, the network appliance and/or the credit allocation system perform one or more acts when the collected traffic data is greater than the predefined threshold. In some examples, the one or more acts comprise collecting additional traffic data relating to the network traffic. In some examples, the additional traffic data comprises protocol data. In some examples, the additional traffic data is exported to a traffic collector to analyze the additional traffic data to determine one or more network issues (e.g., a malfunctioning network component, a source of interference, etc.) and/or facilitate performance of maintenance operations to remedy the one or more network issues. Alternatively and/or additionally, the one or more acts may comprise blocking transmission of a first content item (e.g., the first video 264) to the first client device 200 to ease traffic load through the network appliance. In some examples, the first content item is transmitted to the first client device 200 when the collected traffic data is less than the predefined threshold.

In some examples, the credit allocation system transmits the first content item to the first client device 200 over one or more cryptographic communications between the credit allocation system and the first client device 200. In some examples, the credit allocation system receives a plaintext word signal. The credit allocation system transforms the plaintext word signal to one or more message block word signals M_{A}. In some examples, the credit allocation system encodes each of the message block word signals MA to produce a ciphertext word signal C_{A}. In some examples, C_{A}=M_{A}^{e} (mod n). In some examples, (i) C_{A} is a number representative of an encoded form of message word M_{A}, (ii) M_{A} corresponds to a number representative of a message, (iii) 0≤M_{A}≤n−1, (iv) n is a composite number of the form n=p*q, (v) p and q are prime numbers, and/or (vi) e is a number relatively prime to (p-1)*(q-1). The credit allocation system may transmit the ciphertext word signal C_{A} to the first client device 200 over a communication channel. The ciphertext word signal C_{A} may be indicative of at least a portion of the first content item.

In some examples, a third memory of the first client device 200 comprises a quarantine sector, a non-quarantine sector and/or a boot sector, wherein the quarantine sector may be isolated from (e.g., physically isolated from) the non-quarantine sector and/or the boot sector. In some examples, code in the quarantine sector may be prevented from performing write actions on other memory sectors, such as the non-quarantine sector and/or the boot sector. In some examples, in response to the first client device 200 receiving an electronic communication, the electronic communication is stored in the quarantine sector of the third memory. In some examples, the electronic communication may comprise the first content item. In some examples, the first client device 200 extracts (via file parsing, for example) a malicious code from the electronic communication to create a sanitized electronic communication. The extraction of the malicious code may comprise (i) scanning the communication for an identified beginning malicious code marker, (ii) flagging each scanned byte between the beginning marker and a successive end malicious code marker, (iii) continuing scanning until no further beginning malicious code marker is found, and/or (iv) creating a new data file by sequentially copying non-flagged data bytes (e.g., all non-flagged data bytes) into a new file that forms a sanitized communication file. In some examples, the first client device 200 transfers the sanitized electronic communication to the non-quarantine sector of the third memory. In some examples, the first client device 200 deletes data remaining in the quarantine sector (e.g., the first client device 200 deletes all data remaining in the quarantine sector). In some examples, the first client device 200 renders the first content item for display on a screen (e.g., a touchscreen, a monitor, etc.) of the first client device 200 using the sanitized electronic communication (e.g., the first client device 200 retrieves the sanitized electronic communication from the non-quarantine sector and/or processes information of the sanitized electronic communication to render the first content item).

In some examples, the credit allocation system performs a content-loading process for loading the first content item into a local computer system (e.g., the first client device 200) which has a system processor and volatile memory and non-volatile memory. In some examples, the content-loading process comprises (i) responding to powering up of the local computer system by requesting from a memory location (e.g., remote storage location) remote from the local computer system the transfer to and storage in the volatile memory of the local computer system of the first content item, (ii) transferring and/or storing the first content item, and/or (iii) displaying the first content item on a screen of the local computer system.

In some examples, the credit allocation system comprises (i) a local client computer (e.g., the first client device 200) generating network access requests for said individual controlled access network accounts, (ii) at least one filtering scheme, (iii) a plurality of sets of logical filtering elements, and/or (iv) a remote Internet Service Provider (ISP) server coupled to said client computer and said Internet computer network, said ISP server associating each said network account to at least one filtering scheme and at least one set of filtering elements, said ISP server further receiving said network access requests from said client computer and executing said associated filtering scheme utilizing said associated set of logical filtering elements.

In some examples, the first content item comprises an image (e.g., a gray scale image and/or a video frame of the first video). In some examples, the credit allocation system halftones the first content item by (i) generating, with a processor, a blue noise mask by encoding changes in pixel values across a plurality of blue noise filtered dot profiles at varying gray levels, (ii) storing the blue noise mask in a first memory location, (iii) receiving a gray scale image and storing the gray scale image in a second memory location, (iv) comparing, with a processor on a pixel-by-pixel basis, each pixel of the gray scale image to a threshold number in the corresponding position of the blue noise mask to produce a binary image array, and/or (iv) converting the binary image array to a halftoned image. In some examples, the halftoned image is transmitted to the first client device 200.

Implementation of at least some of the disclosed subject matter may lead to benefits including a reduction in screen space and/or an improved usability of a display (e.g., of the first client device 200) (e.g., as a result of providing enabling users to concurrently watch videos and learn about and/or interact with organizations, where a user does not have to open a separate window to view at least one of related video suggestions (e.g., the first set of related videos 288), creator recommendations, subscriber recommendations, the ranking feature 257, the collaboration feature 265, the export feature 269, etc.)

According to some embodiments, a method for facilitating the allocation of credit to one or more organizations via a video presentation interface is provided. The method includes displaying, in a video presentation interface of a first user, a video, displaying, in the video presentation interface of the first user, a selectable input associated with identifying an organization, receiving an interaction with the selectable input; identifying a first organization, from among a plurality of organizations, based upon the interaction, modifying one or more settings associated with the first user to identify the first organization as being a beneficiary of views of the first user, and responsive to detecting one or more views of one or more videos by the first user after modification of the one or more settings, providing credit associated with the one or more views to a first account of the first organization.

According to some embodiments, the method includes identifying a second organization based upon a second interaction with one or more selectable inputs, modifying the one or more settings associated with the first user to identify the second organization as being a beneficiary of views of the first user, and responsive to detecting one or more views of one or more videos by the first user after modification of the one or more settings to identify the second organization, providing credit associated with the one or more views to a second account of the second organization.

According to some embodiments, the method includes identifying a second organization based upon a second interaction with one or more selectable inputs, modifying the one or more settings associated with the first user to identify the second organization as being a beneficiary of views of the first user, wherein the one or more settings also identify the first organization as being a beneficiary of views of the first user, and responsive to detecting one or more views of one or more videos by the first user after modification of the one or more settings to identify the second organization, providing first credit associated with one or more views to the first account of the first organization and second credit associated with one or more views to a second account of the second organization.

According to some embodiments, the method includes determining a first timestamp corresponding to a selection of a first organization by the first user, storing the first timestamp in a database in association with the first user, determining a second timestamp corresponding to a deselection of the first organization by the first user, storing the second timestamp in the database in association with the first user, determining a time period between the first timestamp and the second timestamp, and determining a first pattern, associated with the first user or the first organization, based upon the time period.

According to some embodiments, the method includes identifying a second pattern associated with a second user or a second organization, comparing the first pattern with the second pattern, and generating one or more recommendations for one or more organizations based upon the comparison.

According to some embodiments, the method includes determining a level of support by the first user for the first organization, wherein the level of support comprises at least one of a number of views or an amount of funding.

According to some embodiments, the method includes presenting a messaging interface to the first user, receiving a selection of one or more target organizations by the first user, and sharing reach information of the first user, comprising the level of support, to the one or more target organizations.

According to some embodiments, the method includes presenting a sharing interface to the first user, receiving a selection of one or more target profiles by the first user, and sharing reach information of the first user, comprising the level of support, to the one or more profiles.

According to some embodiments, the method includes determining a first level of support by the first user for the first organization over a first period of time, determining a second level of support by the first user for the first organization over a second period of time, comparing the first level of support with the second level of support, and generating one or more recommendations based upon the comparison.

In some examples, at least some of the disclosed subject matter may be implemented on a client device, and in some examples, at least some of the disclosed subject matter may be implemented on a server (e.g., hosting a service accessible via a network, such as the Internet).

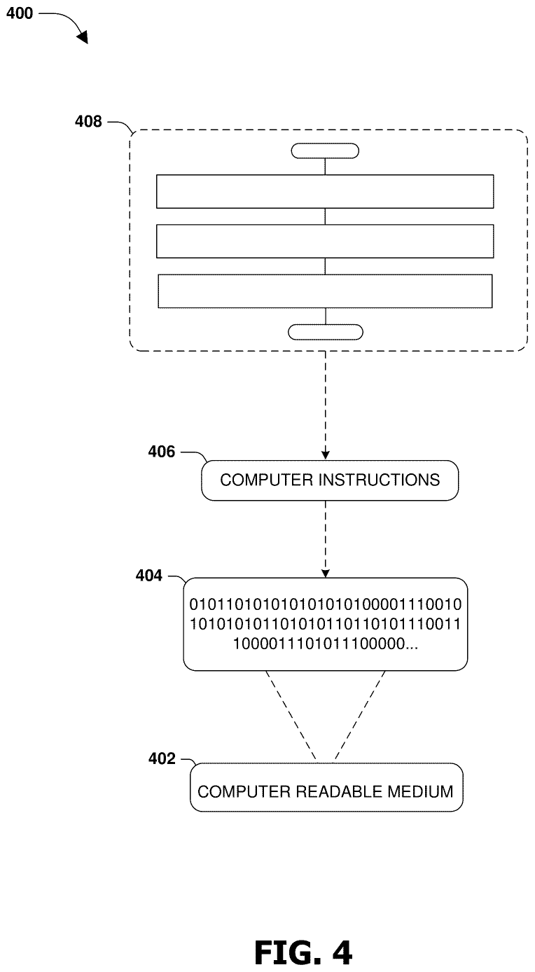

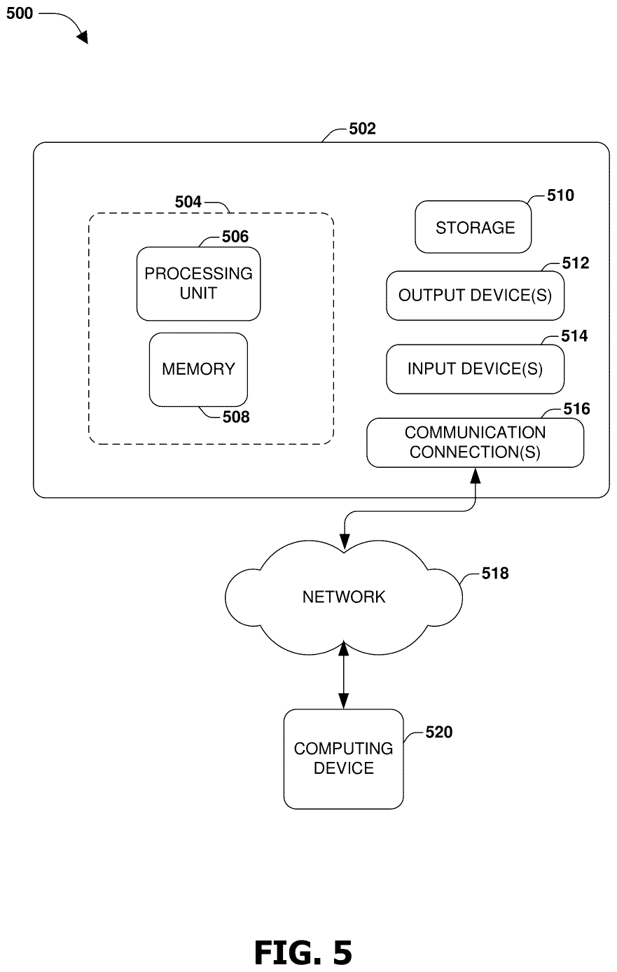

Another embodiment involves a computer-readable medium comprising processor-executable instructions. The processor-executable instructions may be configured to implement one or more of the techniques presented herein. An exemplary computer-readable medium that may be devised in these ways is illustrated in FIG. 4. An implementation 400 may comprise a computer-readable medium 402 (e.g., a CD, DVD, or at least a portion of a hard disk drive), which may comprise encoded computer-readable data 404. The computer-readable data 404 comprises a set of computer instructions 406 configured to operate according to one or more of the principles set forth herein. In one such embodiment 400, the processor-executable computer instructions 406 may be configured to perform a method, such as at least some of the exemplary method 100 of FIG. 1, for example. In another such embodiment, the processor-executable instructions 406 may be configured to implement a system, such as at least some of the exemplary system 201 of FIGS. 2A-2P, and/or at least some of the exemplary system 301 of FIGS. 3A-3B, for example. Many such computer-readable media 502 may be devised by those of ordinary skill in the art that are configured to operate in accordance with the techniques presented herein. FIG. 5 and the following discussion provide a description of a suitable computing environment to implement embodiments of one or more of the provisions set forth herein. The operating environment of FIG. 5 is just one example of a suitable operating environment and is not intended to indicate any limitation as to the scope of use or functionality of the operating environment. Example computing devices include, but are not limited to, server computers, mainframe computers, personal computers, hand-held or laptop devices, mobile devices (such as mobile phones, Personal Digital Assistants (PDAs), media players, and the like), consumer electronics, multiprocessor systems, mini computers, distributed computing environments that include any of the above systems or devices, and the like.

Although not required, embodiments are described in the general context of “computer readable instructions” being executed by one or more computing devices. Computer readable instructions may be distributed using computer readable media (discussed below). Computer readable instructions may be implemented as programs and/or program modules, such as functions, objects, Application Programming Interfaces (APIs), data structures, and the like, that execute particular tasks or implement particular abstract data types. Typically, the functionality of the computer readable instructions may be combined or distributed (e.g., as desired) in various environments.

FIG. 5 illustrates an example of a system 500 comprising a (e.g., computing) device 502. Device 502 may be configured to implement one or more embodiments provided herein. In an exemplary configuration, device 502 includes at least one processing unit 506 and at least one memory 508. Depending on the configuration and type of computing device, memory 508 may be volatile (such as RAM, for example), non-volatile (such as ROM, flash memory, etc., for example), or some combination of volatile and non-volatile. This configuration is illustrated in FIG. 5 by dashed line 504.

In other embodiments, device 502 may include additional features and/or functionality. For example, device 502 may further include additional storage (e.g., removable and/or non-removable) including, but not limited to, magnetic storage, optical storage, and the like. Such additional storage is illustrated in FIG. 5 by storage 510. In one embodiment, computer readable instructions to implement one or more embodiments provided herein may be in storage 510. Storage 510 may further store other computer readable instructions to implement an application program, an operating system, and the like. Computer readable instructions may be loaded in memory 508 for execution by processing unit 506, for example.

The term “computer readable media” as used herein includes computer storage media. Computer storage media includes volatile and/or nonvolatile, removable and/or non-removable media implemented in any method or technology for storage of information such as computer readable instructions or other data. Memory 508 and storage 510 are examples of computer storage media. Computer storage media may include, but is not limited to including, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store desired information and can be accessed by device 502. Any such computer storage media may be part of device 502.

Device 502 may further include communication connection(s) 516 that allows device 502 to communicate with other devices. Communication connection(s) 516 may include, but is not limited to including, a modem, a radio frequency transmitter/receiver, an integrated network interface, a Network Interface Card (NIC), a USB connection, an infrared port, or other interfaces for connecting device 502 to other computing devices. Communication connection(s) 516 may include a wireless connection and/or a wired connection. Communication connection(s) 616 may transmit and/or receive communication media.

The term “computer readable media” may include, but is not limited to including, communication media. Communication media typically embodies computer readable instructions and/or other data in a “modulated data signal” such as a carrier wave or other transport mechanism and includes any information delivery media. The term “modulated data signal” may correspond to a signal that has one or more of its characteristics set or changed in such a manner as to encode information in the signal.

Device 502 may include input device(s) 514 such as mouse, keyboard, voice input device, pen, infrared cameras, touch input device, video input devices, and/or any other input device. Output device(s) 512 such as one or more displays, speakers, printers, and/or any other output device may also be included in device 502. Input device(s) 514 and output device(s) 512 may be connected to device 502 using a wireless connection, wired connection, or any combination thereof. In one embodiment, an input device or an output device from another computing device may be used as input device(s) 514 or output device(s) 512 for device 502.

Components of device 502 may be connected by various interconnects (e.g., such as a bus). Such interconnects may include a Peripheral Component Interconnect (PCI), such as a Universal Serial Bus (USB), PCI Express, an optical bus structure, firewire (IEEE 1394), and the like. In another embodiment, components of device 502 may be interconnected by a network. In an example, memory 508 may be comprised of multiple (e.g., physical) memory units located in different physical locations interconnected by a network.

Storage devices utilized to store computer readable instructions may be distributed across a network. For example, a computing device 520 accessible using a network 518 may store computer readable instructions to implement one or more embodiments provided herein. Device 502 may access computing device 520 and download a part or all of the computer readable instructions for execution. Alternatively, device 502 may download pieces of the computer readable instructions, as needed, or some instructions may be executed at device 502 and some at computing device 620.

Various operations of embodiments are provided herein. In one embodiment, one or more of the operations described may comprise computer readable instructions stored on one or more computer readable media, which if executed by a computing device, will cause the computing device to perform the operations described. The order in which some or all of the operations are described should not be construed as to imply that these operations are order dependent. Alternative ordering will be appreciated by one skilled in the art having the benefit of this description. Further, it will be understood that not all operations are present in each embodiment provided herein.

Although the subject matter has been described in language specific to structural features and/or methodological acts, it is to be understood that the subject matter defined in the appended claims is not limited to the specific features or acts described above. Rather, the specific features and acts described above are disclosed as example forms of implementing the claims.

As used in this application, the terms “system”, “component,” “interface”, “module,” and the like are generally intended to refer to a computer-related entity, either hardware, software, a combination of hardware and software, or software in execution. For example, a component may be, but is not limited to being, an object, a process running on a processor, a processor, a program, an executable, a thread of execution, and/or a computer. By way of illustration, an application running on a controller and the controller can be a component. One or more components may reside within a thread of execution and/or process and a component may be distributed between two or more computers and/or localized on one computer.

Furthermore, the claimed subject matter may be implemented as an apparatus, method, and/or article of manufacture using standard programming and/or engineering techniques to produce hardware, firmware, software, or any combination thereof to control a computer that may implement the disclosed subject matter. The term “article of manufacture” as used herein is intended to encompass a computer program (e.g., accessible from any computer-readable device, carrier, or media). Of course, those skilled in the art will recognize many modifications may be made to this configuration without departing from the scope or spirit of the claimed subject matter.

Moreover, the word “exemplary” is used herein to mean serving as an example, illustration, or instance. Any design or aspect described herein as “exemplary” is not necessarily to be construed as advantageous over other designs or aspects. Rather, use of the word “exemplary” is intended to present concepts in a concrete fashion. As used in this application, the word “or” is intended to mean an inclusive “or” (e.g., rather than an exclusive “or”). That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the words “a” and “an” as used in this application and the appended claims may generally be construed to mean “one or more” (e.g., unless specified otherwise or clear from context to be directed to a singular form). Also, at least one of A or B or the like generally means A or B or both A and B. Furthermore, to the extent that the terms “includes”, “having”, “has”, “with”, or variants thereof are used in either the detailed description or the claims, such terms are intended to be inclusive in a manner similar to the term “comprising.”

Although the disclosure has been shown and described with respect to one or more implementations, modifications and alterations will occur to others skilled in the art based (e.g., at least in part) upon a reading of this specification and the annexed drawings. The disclosure includes all such modifications and alterations. The disclosure is limited only by the scope of the following claims. In regard to the various functions performed by the above described components (e.g., resources, elements, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. Additionally, while a particular feature of the disclosure may have been disclosed with respect to only one of several implementations, the particular feature may be combined with one or more other features of the other implementations as may be desired and/or advantageous for any given or particular application.

What is claimed is:

1. A method for using a video presentation interface to facilitate the allocation of credit to one or more organizations, the method comprising:
displaying, in a video presentation interface of a first user, a video;
displaying, in the video presentation interface of the first user, a selectable input associated with identifying an organization;
receiving an interaction with the selectable input;
identifying a first organization, from among a plurality of organizations, based upon the interaction;
modifying one or more settings associated with the first user to identify the first organization as being a beneficiary of views of the first user; and
responsive to detecting one or more views of one or more videos by the first user after modification of the one or more settings, providing credit associated with the one or more views to a first account of the first organization.

2. The method of claim 1, comprising:
identifying a second organization based upon a second interaction with one or more selectable inputs;
modifying the one or more settings associated with the first user to identify the second organization as being a beneficiary of views of the first user; and
responsive to detecting one or more views of one or more videos by the first user after modification of the one or more settings to identify the second organization, providing credit associated with the one or more views to a second account of the second organization.

3. The method of claim 1, comprising:
identifying a second organization based upon a second interaction with one or more selectable inputs;
modifying the one or more settings associated with the first user to identify the second organization as being a beneficiary of views of the first user, wherein the one or more settings also identify the first organization as being a beneficiary of views of the first user; and
responsive to detecting one or more views of one or more videos by the first user after modification of the one or more settings to identify the second organization, providing first credit associated with one or more views to the first account of the first organization and second credit associated with one or more views to a second account of the second organization.

4. The method of claim 1, comprising:
determining a first timestamp corresponding to a selection of a first organization by the first user;
storing the first timestamp in a database in association with the first user;
determining a second timestamp corresponding to a deselection of the first organization by the first user;
storing the second timestamp in the database in association with the first user;
determining a time period between the first timestamp and the second timestamp; and
determining a first pattern, associated with the first user or the first organization, based upon the time period.

5. The method of claim 4, comprising:
identifying a second pattern associated with a second user or a second organization;
comparing the first pattern with the second pattern; and
generating one or more recommendations for one or more organizations based upon the comparison.

6. The method of claim 1, comprising:
determining a level of support by the first user for the first organization, wherein the level of support comprises at least one of a number of views or an amount of funding.

7. The method of claim 6, comprising:
presenting a messaging interface to the first user;
receiving a selection of one or more target organizations by the first user; and
sharing reach information of the first user, comprising the level of support, to the one or more target organizations.

8. The method of claim 6, comprising:
presenting a sharing interface to the first user;
receiving a selection of one or more target profiles by the first user; and
sharing reach information of the first user, comprising the level of support, to the one or more profiles.

9. The method of claim 1, comprising:
determining a first level of support by the first user for the first organization over a first period of time;
determining a second level of support by the first user for the first organization over a second period of time;
comparing the first level of support with the second level of support; and
generating one or more recommendations based upon the comparison.

10. A computing device comprising:
a processor coupled to memory, the processor configured to execute instructions from the memory to perform operations comprising:
displaying, in a video presentation interface of a first user, a video;
displaying, in the video presentation interface of the first user, a selectable input associated with identifying an organization;
receiving an interaction with the selectable input;
identifying a first organization, from among a plurality of organizations, based upon the interaction;
modifying one or more settings associated with the first user to identify the first organization as being a beneficiary of views of the first user; and
responsive to detecting one or more views of one or more videos by the first user after modification of the one or more settings, providing credit associated with the one or more views to a first account of the first organization.

11. The computing device of claim 10, the operations comprising:
identifying a second organization based upon a second interaction with one or more selectable inputs;
modifying the one or more settings associated with the first user to identify the second organization as being a beneficiary of views of the first user; and
responsive to detecting one or more views of one or more videos by the first user after modification of the one or more settings to identify the second organization, providing credit associated with the one or more views to a second account of the second organization.

12. The computing device of claim 10, the operations comprising:
identifying a second organization based upon a second interaction with one or more selectable inputs;
modifying the one or more settings associated with the first user to identify the second organization as being a beneficiary of views of the first user, wherein the one or more settings also identify the first organization as being a beneficiary of views of the first user; and
responsive to detecting one or more views of one or more videos by the first user after modification of the one or more settings to identify the second organization, providing first credit associated with one or more views to the first account of the first organization and second credit associated with one or more views to a second account of the second organization.

13. The computing device of claim 10, the operations comprising:
determining a first timestamp corresponding to a selection of a first organization by the first user;
storing the first timestamp in a database in association with the first user;
determining a second timestamp corresponding to a deselection of the first organization by the first user;
storing the second timestamp in the database in association with the first user;
determining a time period between the first timestamp and the second timestamp; and
determining a first pattern, associated with the first user or the first organization, based upon the time period.

14. The computing device of claim 13, the operations comprising:
identifying a second pattern associated with a second user or a second organization;
comparing the first pattern with the second pattern; and
generating one or more recommendations for one or more organizations based upon the comparison.

15. The computing device of claim 10, the operations comprising:
determining a level of support by the first user for the first organization, wherein the level of support comprises at least one of a number of views or an amount of funding.

16. The computing device of claim 15, the operations comprising:
presenting a messaging interface to the first user;
receiving a selection of one or more target organizations by the first user; and
sharing reach information of the first user, comprising the level of support, to the one or more target organizations.

17. The computing device of claim 15, the operations comprising:
presenting a sharing interface to the first user;
receiving a selection of one or more target profiles by the first user; and
sharing reach information of the first user, comprising the level of support, to the one or more profiles.

18. The computing device of claim 10, the operations comprising:
determining a first level of support by the first user for the first organization over a first period of time;
determining a second level of support by the first user for the first organization over a second period of time;
comparing the first level of support with the second level of support; and
generating one or more recommendations based upon the comparison.

19. A non-transitory computer-readable medium storing instructions that when executed perform operations comprising:
displaying, in a video presentation interface of a first user, a video;
displaying, in the video presentation interface of the first user, a selectable input associated with identifying an organization;
receiving an interaction with the selectable input;
identifying a first organization, from among a plurality of organizations, based upon the interaction;
modifying one or more settings associated with the first user to identify the first organization as being a beneficiary of views of the first user; and
responsive to detecting one or more views of one or more videos by the first user after modification of the one or more settings, providing credit associated with the one or more views to a first account of the first organization.

20. The non-transitory computer-readable medium of claim 19, comprising:
identifying a second organization based upon a second interaction with one or more selectable inputs;
modifying the one or more settings associated with the first user to identify the second organization as being a beneficiary of views of the first user; and
responsive to detecting one or more views of one or more videos by the first user after modification of the one or more settings to identify the second organization, providing credit associated with the one or more views to a second account of the second organization.
